(19) United States
(12) Patent Application Publication
(10) Pub. No.: US 2018/0281253 A1
(43) Pub. Date: Oct. 4, 2018

(54) GAS EXHAUSTING DEVICE FOR INJECTION MOLD

(71) Applicant: Cheon Seop KIM, Busan (KR)

(72) Inventor: Cheon Seop KIM, Busan (KR)

(21) Appl. No.: 15/660,229

(22) Filed: Jul. 26, 2017

(30) Foreign Application Priority Data
Apr. 4, 2017 (KR) 10-2017-0043812

(51) Int. Cl. B29C 45/34; F16K 17/04; F16K 31/122

(52) U.S. Cl. CPC B29C 45/34; F16K 31/1221; F16K 17/044

(57) ABSTRACT

Provided is a gas exhausting device for an injection mold. The gas exhausting device includes: an introduction socket; an introduction holder provided at an inner portion of the introduction socket in a transverse direction; a poppet including a body, a head, and a support ring; a first elastic member interposed between the head of the poppet and the introduction holder to elastically support one end of the poppet; and a second elastic member interposed between the support ring of the poppet and the introduction holder to elastically support an opposite end of the poppet, wherein the first elastic member includes a first compression coil spring installed in a compressed state, the second elastic member includes a second compression coil spring installed in a compressed state, and a spring constant of the first compression coil spring is larger than a spring constant of the second compression coil spring.

### CROSS REFERENCES

Applicant claims foreign priority under Paris Convention to Korean Patent Application No. 10-2017-0043812, filed 4 Apr. 2017, with the Korean Intellectual Property Office, where the entire contents are incorporated herein by reference.

### BACKGROUND

The present invention relates to a gas exhausting device for an injection mold, and more particularly, to a gas exhausting device for an injection mold, capable of smoothly sucking and discharging a gas remaining in a cavity of the injection mold during an injection-molding process.

In general, when a mold is used to manufacture an injection-molded article, a molten resin is injected into a cavity defined by an upper mold and a lower mold coupled with the upper mold. At this time, a soluble resin such as a plastic is widely used as the molten resin.

However, the air accommodated in the cavity may not be completely discharged as the molten resin is rapidly injected into the cavity. If an injection-molded product is manufactured with the molten resin, which is cooled while being mixed with the air remaining in the cavity, the injection-molded product may have various defects including air bubbles and porosity.

In particular, when outsoles, midsoles, insoles and the like of shoes are manufactured by injection-molding, an additive is mixed with a resin such as EVA and the mixture is injected. At this time, a gas is generated as the additive is vaporized by heat. Therefore, one of the major problems to be solved upon the manufacture of the injection-molded article is to discharge the air inside the cavity and the gas generated during the injection-molding.

In order to solve the above problem, Korean Patent Registration No. 10-1684222 proposes a gas exhausting device for an injection mold, in which the gas exhausting device for discharging a gas, which is present in a cavity of the injection mold including a movable mold and a fixed mold, to an outside includes: a main body coupled with the fixed mold while passing outward through the fixed mold from an inner peripheral surface of the cavity of the fixed mold, and having a first hollow for discharging the gas in the cavity to the outside, such that an inlet portion of the first hollow formed on a cavity side has an inner diameter gradually narrowing toward an inner side, and an outlet portion of the first hollow formed on an opposite side of the cavity has a plurality of first communication holes which communicates with the inlet portion; an opening-closing member having a shape of a screw inserted into the first hollow of the main body while being elastically supported by an elastic member to open and close the inlet portion according to reciprocating movement of a head portion corresponding to the inlet portion of the first hollow disposed on the cavity side; a support member coupled to a penetration surface of the fixed mold to support the main body, and having a second hollow for guiding the gas passed through the first hollow of the main body to the outside; and a gas discharge control unit interposed between the main body and the support member to block or open at least a part of the first communication hole.

According to the related art, since the head portion of the opening-closing member opens and closes a cavity-side inlet of the first hollow while being elastically supported by one elastic member, if an elastic force of the elastic member is decreased due to repeated opening and closing, a distance between the head portion and the cavity-side inlet of the first hollow is decreased, so that the gas remaining in the cavity of the injection mold cannot be smoothly sucked and discharged.

In other words, when the vacuum pressure is applied to discharge the gas remaining in the cavity to the outside, if the elastic force of the elastic member is decreased, the head portion is closed by the vacuum pressure before the gas is discharged, so that the gas cannot discharged.

In addition, the head portion has to return to its original state when the next injection-molding process is performed. If the elastic force of the elastic member is decreased, the head portion is not completely returned to a state that the first hollow is completely opened, so that the gas is not smoothly discharged during the next injection-molding process.

As another related art, there is Korean Patent Registration No. 10-1480048 disclosing an air vent device for an injection mold, in which the air vent device installed in a discharge path formed at one side of a molding space to discharge air and gas, which are present in the molding space, to the outside when a molding material is injected includes: a body provided at a front end of the discharge path, having a through-hole formed vertically through the body to allow the molding space to communicate with the discharge path, having an accommodation space at an upper portion of the through-hole, having a first discharge hole which is formed at a lower portion of the through-hole and has a diameter smaller than a diameter of the accommodation space, and having a support pipe which is provided at a lower side of the accommodation space and has a first ascending slope inclined downwards and outwards; a first elastic member provided at a lower side of the accommodation space; a descending core installed at an upper side of the accommodation space so as to be movable downwards while being upwardly supported by the first elastic member, provided at an upper end thereof with a press slope to which injection pressure of the molding material is applied, having a second discharge hole which is formed vertically through the descending core and includes a horizontal portion and a vertical portion to allow the molding space to communicate with the first discharge hole, and having a descending slope which is provided at an inner peripheral surface of the vertical portion of the second discharge hole and inclined downwards and outwards from a position higher than a position of the first ascending slope, in which when the molding material is injected, the air and gas are discharged to the first discharge hole through the second discharge hole, and the descending core moves downwards if the injection pressure of the molding material reaches a predetermined level or more; a second elastic member provided at an inner upper side of the second discharge hole to upwardly support the descending core; an ascending core installed at an inner upper side of the second discharge hole so as to be movable upwards while being downwardly supported by the second elastic member, provided at an upper portion thereof with a control piece for controlling the horizontal portion of the second discharge hole according to movement, and provided at a lower portion thereof with an ascending piece, which has a support end provided at an upper end of the ascending piece to support the second elastic member and has a second ascending slope provided at a lower end of the ascending piece and inclined downwards toward a center of the ascending piece, in which the ascending core closes the horizontal portion of the second discharge hole to prevent leakage of the molding material when the descending core is moved downwards; and a plurality of ascending guide balls provided at a predetermined interval while making contact with the first ascending slope, the descending slope, and the second ascending slope ant an inside of the second discharge hole, in which when the descending core is moved downwards, the guide ball is separated from the descending slope, and moves the ascending core upwards as the guide ball makes contact with the inner peripheral surface of the vertical portion of the second discharge hole so as to shorten a time for closing the horizontal portion of the second discharge hole.

In the above-described related art, two elastic members (the first elastic member and the second elastic member) are used. Both of the elastic members are compressed when the descending core is closed, and the two elastic members that have been compressed extend together, so that the descending core is easily returned to the original state. Moreover, since the elastic members disperse the injection pressure, the elastic force can be prevented from decreasing.

However, since the two elastic members are connected in series, the elastic modulus is large, which causes the descending core not to be closed by the injection pressure, so that the molding material may be discharged to the second discharge hole. However, if the elastic modulus of both the first elastic member and the second elastic member is decreased, the descending core may not smoothly return.

### SUMMARY OF THE INVENTION

To solve the problems described above, an object of the present invention is to provide a gas exhausting device for an injection mold, capable of smoothly sucking and discharging air or gas remaining in a cavity of the injection mold during an injection-molding process. In detail, there is provided a gas exhausting device for an injection mold, in which a poppet is closed by the injection pressure without being closed by the external vacuum pressure for gas suction, and the poppet is rapidly opened again by the elastic member when the injection-molding process is completed.

Another object of the present invention is to provide a gas exhausting device for an injection mold, in which two compression coil springs are used to improve the durability and lifespan of the gas exhausting device.

To achieve the objects described above, according to the present invention, there is provided a gas exhausting device for an injection mold, the gas exhausting device including: an introduction socket having a tubular shape, provided in a discharge path which is formed through an inner surface of the injection mold, and allowing a cavity to communicate with an outside to introduce and discharge a gas remaining in the cavity; an introduction holder provided at an inner portion of the introduction socket in a transverse direction to divide the inner portion of the introduction socket into a first gas introduction path and a second gas introduction path, formed at a center thereof with a central hole through which a poppet penetrates, and having a plurality of gas communication paths formed around an outer side of the central hole; a poppet including a body penetrating through the central hole, a head formed at one end of the body to open and close the first gas introduction path by reciprocating movement, and a support ring provided at an opposite end of the body; a first elastic member interposed between the head of the poppet and the introduction holder to elastically support one end of the poppet; and a second elastic member interposed between the support ring of the poppet and the introduction holder to elastically support an opposite end of the poppet, wherein the first elastic member includes a first compression coil spring installed in a compressed state, the second elastic member includes a second compression coil spring installed in a compressed state, and a spring constant of the first compression coil spring is larger than a spring constant of the second compression coil spring.

In addition, a diameter of the second compression coil spring may be larger than a diameter of the first compression coil spring.

In addition, when the head of the poppet blocks the first gas introduction path, the first compression coil spring may be further compressed, and the second compression coil spring may extend by a compressed length of the first compression coil spring while maintaining a compressed state without being completely released.

In addition, a linear guide having a tubular shape may be installed in the central hole of the introduction holder to guide the body of the poppet.

In addition, the support ring may include a washer that is able to be fitted to the body of the poppet, a pin hole may be formed at an end portion of the body, and a support pin may be inserted into the pin hole to prevent the washer from being separated.

Meanwhile, the introduction socket may be provided on an outer peripheral surface thereof with a male screw thread to allow the introduction socket to be screw-coupled to the mold.

In addition, the introduction holder may be screw-coupled with an inner peripheral surface of the introduction socket, such that the introduction holder is vertically movable.

According to the present invention having the above-described configuration, two compression coil springs having a spring constant different from each other are used, so that the poppet is easily closed by the injection pressure without being closed by the vacuum pressure for sucking the gas. Accordingly, it is possible to smoothly discharge the gas while effectively preventing the leakage of the molten resin.

In addition, when the injection-molding process is completed, the poppet can be smoothly opened as the first compression coil spring having a larger spring constant is restored.

In addition, the durability and lifespan of components can be improved by dispersing fatigue of the two compression coil springs caused by the repeated compression and extension.

### BRIEF DESCRIPTION OF THE DRAWINGS

FIG. 1 is a perspective view showing a gas exhausting device for an injection mold according to one embodiment of the present invention.

FIG. 2 is an exploded perspective view of the present invention shown in FIG. 1.

FIG. 3 is a sectional view of the present invention shown in FIG. 1.

FIG. 4 is a view showing an operation state of the present invention.

FIG. 5 is a sectional view showing a gas exhausting device for an injection mold according to another embodiment of the present invention.

### DETAILED DESCRIPTION OF THE INVENTION

Hereinafter, one embodiment according to the present invention will be described in more detail with reference to the accompanying drawings.

Note that although the present invention will be described with reference to the accompanying drawings for a better understanding, the present invention is not limited thereto. In addition, detailed descriptions of well-known functions and structures incorporated herein may be omitted when they make the subject matter rather unclear.

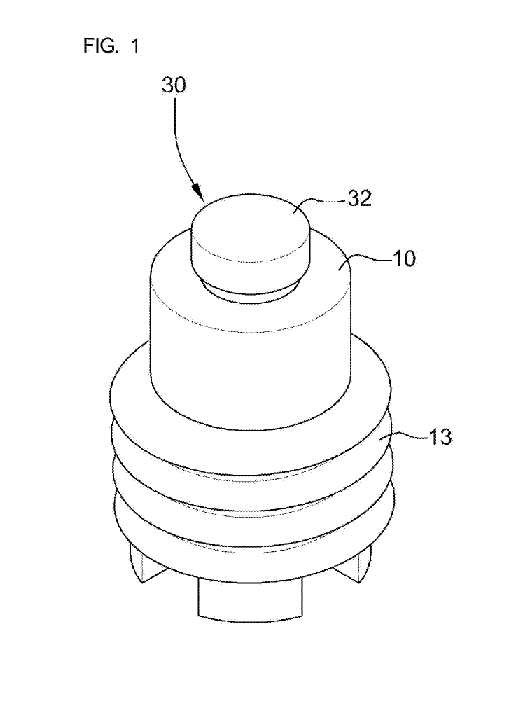

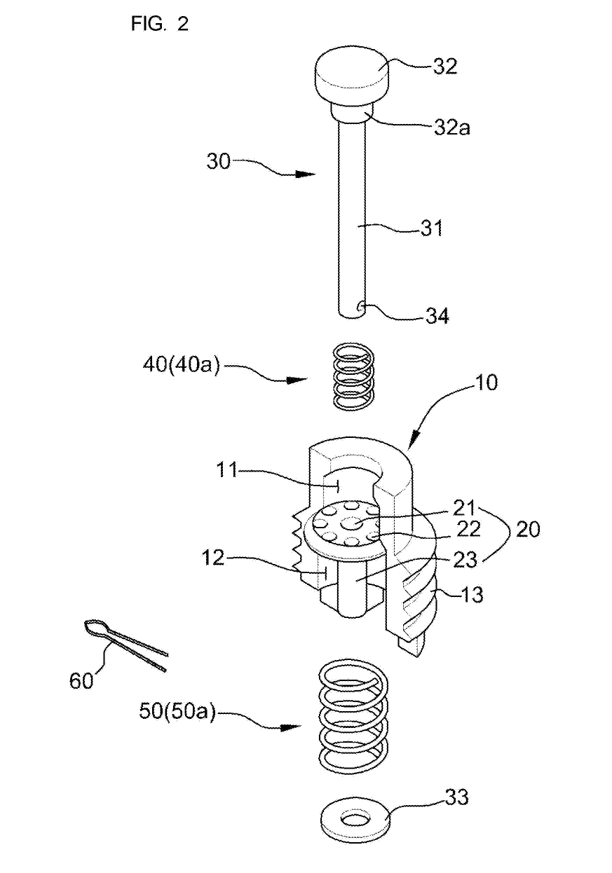

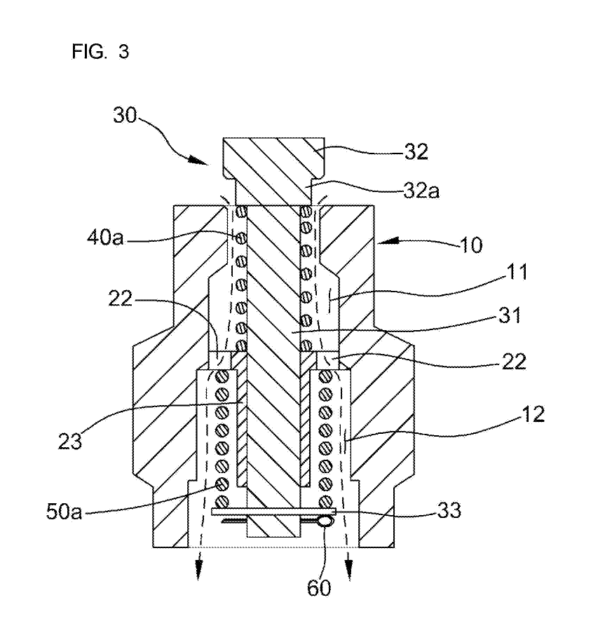

FIG. 1 is a perspective view showing a gas exhausting device for an injection mold according to one embodiment of the present invention, FIG. 2 is an exploded perspective view of the present invention shown in FIG. 1, and FIG. 3 is a sectional view of the present invention shown in FIG. 1.

As shown in the drawings, a gas exhausting device for an injection mold according to the present invention is provided to discharge air or gas remaining in a cavity of the injection mold, and may include an introduction socket 10, an introduction holder 20, a poppet 30, a first elastic member 40, and a second elastic member 50.

First, the introduction socket 10 may have a substantially tubular or pipe shape, which is a vertically perforated to allow the fluid to pass therethrough. The introduction socket 10 may have a cylinder shape and may be installed in a discharge path (not shown) formed through an inner surface of the injection mold.

To this end, a female screw thread provided on an inner peripheral surface of the discharge path is screw-coupled with a male screw thread 13 provided on an outer peripheral surface of the introduction socket 10.

Accordingly, the introduction socket 10 has a structure that the cavity inside the injection mold communicates with an outside of the injection mold, so that the gas or air remaining in the cavity can be introduced into one side of the introduction socket 10 from the cavity, and discharged to the outside of the injection mold through the other side of the introduction socket 10.

An inner peripheral surface of the introduction socket 10 may have the same inner diameter. As shown in the drawings, the inner diameters of a first gas introduction path 11 and a second gas introduction path 12, which are partitioned based on the introduction holder 20 that will be described later, may be different from each other.

In other words, the introduction socket 10 may have a stepped configuration, in which the inner diameter of the first gas introduction path 11 is larger than the inner diameter of the second gas introduction path 12, or may have a tapered shape such that the inner diameter may gradually expand.

In addition, an inlet side of the introduction socket 10, that is, an inlet side communicating with the cavity of the injection mold may be smaller than the inner diameter of the first gas introduction path 11, while being smaller than the outer diameter of a head 32 of the poppet 30, which will be described later.

Next, the introduction holder 20 may be installed at an inner central portion of the introduction socket 10 in a transverse direction. In other words, the introduction holder 20 has a shape corresponding to a sectional shape of the introduction socket 10 when viewed in a section view, so as to divide the inner portion of the introduction socket 10 into the first gas introduction path 11 communicating with the cavity of the injection mold and the second gas introduction path 12 communicating with the outside of the injection mold.

In addition, the introduction holder 20 may be formed at a center thereof with a central hole 21 and may have a plurality of gas communication paths 22 formed at a periphery of the central hole 21. In other words, the poppet, which will be described later, is inserted into and penetrates through the central hole 21, and the gas communication path 22 allows the first gas introduction path 11 to communicate with the second gas introduction path 12, so that the gas may pass through the gas communication path 22.

In an embodiment, if the introduction socket 10 has a cylindrical inner peripheral surface, the introduction holder 20 may have a shape of a circular disc, and the gas communication paths 22 may be formed at a periphery of the central hole 21 along the circumference of the central hole 21.

Meanwhile, a linear guide 23 having a tubular shape may be installed in the central hole 21 of the introduction holder 20 to guide a body 31 of the poppet 30. The linear guide 23 communicates with the central hole 21, so that the body 31 may be inserted into the linear guide 23 while being inserted into the central hole 21.

In other words, the linear guide 23 functions to guide the body 31 so that the body 31 may reciprocally move in a straight line without swaying from side to side. At this time, the linear guide 23 may extend in a gas flow direction, that is, in an outward direction of the injection mold.

Next, the poppet 30 may include the head 32, the body 31, and a support ring 33.

The body 31 may have a rod shape, and may be inserted into the central hole 21 of the introduction holder 20 so as to reciprocally movable.

In addition, the body 31 may be provided at one end thereof with the head 32, in which the head 32 is accommodated in the cavity of the injection mold, and the head 32 has an outer diameter larger than the outer diameter of the body 31, so that the first gas introduction path 11 of the introduction socket 10 may be opened and closed by reciprocating movement.

In other words, the head 32 of the poppet 30 is initially in a state of opening the first gas introduction path 11, and the head 32 is pressed by the injection pressure of the molten resin introduced into the cavity of the injection mold so as to be moved in the direction of closing the first gas introduction path 11, thereby closing the first gas introduction path 11.

The head 32 may have a compression latching sill 32a having an outer diameter larger than the outer diameter of the body 31, in which the first elastic member 40 that will be described later may be latched to the compression latching sill 32a. The compression latching sill 32a will be described later in detail.

Meanwhile, the body 31 may be provided at the other end thereof with the support ring 33.

The support ring 33 serves to extend the outer diameter of the other end of the body 31, and may have a shape of a disc radially extending from the body 31, or may have a shape of a ring-shaped washer additionally fitted around the body 31.

In the case of fitting the washer, a support pin 60 may be additionally inserted into the other end of the body 31 to prevent the washer from being separated. To this end, a pin hole 34 is formed through the other end of the body 31, and the support pin 60 is inserted through the pin hole 34.

Therefore, if it is separable like the washer, the poppet 30, the first elastic member 40, and the second elastic member 50, which are installed in the introduction socket 10, can be disassembled by removing the pinhole 34 and separating the washer. Accordingly, each component that has reached end of its lifespan can be disassembled and replaced.

Next, the first elastic member 40 will be described.

The first elastic member 40 is interposed between the introduction holder 20 and the head 32 of the poppet 30, and elastically supports one end of the poppet 30, that is, the head.

In the present invention, the first elastic member 40 may include a first compression coil spring 40a.

The compression coil spring is a steel wire wound in the form of a coil, and is a member that elastically supports against a compressive force.

The first compression coil spring 40a is spirally wound around an outer periphery of the body 31 to elastically support the head 32 in a state that both ends of the first compression coil spring 40a are latched to the head 32 of the poppet 30 and one side surface of the introduction holder 20, respectively. Accordingly, the head 32 maintains the first gas introduction path 11 in an open state all the time.

In addition, the first compression coil spring 40a is not interposed in an initial state in which no compression force is applied, but is interposed in a compressed state to elastically press the head 32. This will be described later in detail, because it is interlocked with a second compression coil spring 50a that will be described later.

The first compression coil spring 40a may be interposed in a state of being latched to the head 32 or may be interposed in a compressed state by the compression latching sill 32a.

Next, the second elastic member 50 is interposed between the introduction holder 20 and the support ring 33 of the poppet 30 to elastically support the other end of the poppet 30, that is, the support ring 33.

In addition, the second elastic member 50 may include the second compression coil spring 50a.

The second compression coil spring 50a is spirally wound around the outer periphery of the body 31 to elastically support the support ring 33 in a state that both ends of the second compression coil spring 50a are latched to the support ring 33 of the poppet 30 and the other side surface of the introduction holder 20, respectively. Accordingly, the head 32 of the poppet 30 elastically supports the first gas introduction path 11 in a direction of closing the first gas introduction path 11. Alternatively, the second compression coil spring 50a may be wound around an outer periphery of the linear guide 23.

In addition, the second compression coil spring 50a is interposed in a compressed state to elastically press the support ring 33.

In detail, when the first compression coil spring 40a and the second compression coil spring 50a are installed in the poppet 30, the distance between the head 32 and the introduction holder 20 is shorter than the initial length of the first compression coil spring 40a, and the distance between the support ring 33 and the introduction holder 20 is shorter than the initial length of the second compression coil spring 50a, so that both the second compression coil spring 50a and the first compression coil spring 40a maintain the compressed state while the elastic forces are balanced with each other.

A salient feature of the present invention is that the spring constant of the first compression coil spring 40a is larger than the spring constant of the second compression coil spring 50a.

A large spring constant signifies the greater elastic force, which indicates that the strain is smaller for the same compressive force.

Therefore, since the elastic force of the first compression coil spring 40a is larger than the elastic force of the second compression coil spring 50a, the second compression coil spring 50a is compressed more than the first compression coil spring 40a, so that the head 32 of the poppet 30 maintains the first gas introduction path 11 in the open state.

In detail, in order to design the first compression coil spring 40a to have a larger spring constant, the diameter of the second compression coil spring 50a may be designed to be larger than the diameter of the first compression coil spring 40a.

In general, a spring constant K of a coil spring is expressed as follows.

$$K = \frac{{Gd}^{4}}{8 n {D}^{3}}$$

In the above expression, G denotes the transverse elastic modulus of a spring material, d denotes the diameter of a coil, D denotes the diameter of a spring, and n denotes the number of effective turns.

Therefore, if other features are constant, the spring constant can be decreased by designing D to be larger.

In addition, it may be appropriate to design the second compression coil spring to have a larger diameter in the present invention, because the inner diameter of the second gas introduction path where the second compression coil spring is installed is larger than the inner diameter of the first gas introduction path.

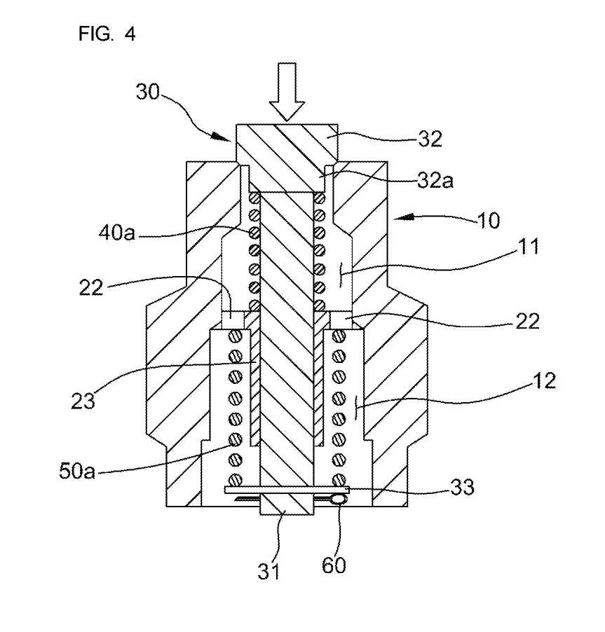

Hereinafter, the operation of the present invention will be described with reference to FIGS. 3 and 4. FIG. 4 is a view showing an operation state of the present invention. The dotted arrows shown in FIG. 3 represent the gas flow, and the bold arrows shown in FIG. 4 represent the injection pressure.

The present invention is screw-coupled onto the discharge path formed through the inner surface of the injection mold, in which the head 32 of the poppet 30 is accommodated in the cavity inside the injection mold, and the support ring 33 of the poppet 30 is directed to the outside of the injection mold.

At this time, a vacuum pump for applying the vacuum pressure may be additionally provided at the outside of the injection mold and connected to the discharge path so as to smoothly suck the gas. Note that the vacuum pressure may be approximately −50 to −70 Kpa.

First, when the molten resin is injected into the cavity of the injection mold, since the poppet is in an open state, the gas or air in the cavity is discharged. In addition, since the vacuum pressure is applied from the outside of the injection mold, the gas is smoothly discharged as indicated by the dotted arrows shown in FIG. 3.

At this time, the first compression coil spring 40a and the second compression coil spring 50a are partially compressed, and the head 32 of the poppet 30 is pressed by the elastic force of the first compression coil spring 40a and completely opened.

In addition, even when the vacuum pressure is applied, the head 32 of the poppet 30 is not closed due to the elastic force of the first compression coil spring 40a. In other words, it is preferred that the first compression coil spring 40a has a spring constant value, which is enough to elastically support the head 32 so that the head 32 is not closed even when an attractive force (pulling force) acts on the head 32 due to the vacuum pressure, and enables the first compression coil spring 40a to be pressed by the injection pressure so that the head 32 is easily closed by the injection pressure.

The reason is that if the spring constant value is too small, the head 32 is closed by the vacuum pressure before the injection is performed, and if the value of the spring constant is too large, the head 32 is not closed even by the injection pressure, so that the molten resin is discharged through the first gas introduction path 11.

When the molten resin is almost filled in the cavity, the head 32 of the poppet 30 is pressed by the injection pressure of the molten resin as shown by the bold arrows in FIG. 4. In addition, the first compression coil spring 40a is compressed by the head 32, and the head 32 closes the first gas introduction path 11 of the introduction socket 10 as the poppet 30 moves.

In addition, the head 32 is closed more rapidly by the vacuum pressure. In other words, since the head 32 may not be closed by only the injection pressure without the vacuum pressure, the head is very easily closed if the injection pressure is applied in a state that the vacuum pressure is applied.

At this time, the second compression coil spring 50a extends (expands).

In other words, the second compression coil spring 50a is interposed in a compressed state before the start of the injection process, and when the poppet 30 is closed as the injection process is started, the second compression coil spring 50a extends, contrary to the first compression coil spring 40a. That is, since the second compression coil spring 50a partially reduces the elastic resistance of the first compression coil spring 40a, the poppet 30 can be more easily closed.

Note that even when the second compression coil spring 50a extends, it does not extend up to the initial state that is not compressed, but extends with a certain level of compression. In other words, the second compression coil spring 50a extends by a compressed length of the first compression coil spring 40a, in which an extending length of the second compression coil spring 50a is shorter than the compressed length of the second compression coil spring 50a in the original initial state, so that even if the head is closed, the second compression coil spring 50a still maintains the partially compressed state without releasing the compressed state.

In the case of using only the first compression coil spring 40a without the second compression coil spring 50a, in order to close the poppet 30 by the injection pressure, the first compression coil spring 40a having a smaller spring constant has to be used. When the injection pressure is removed as the injection process is completed and the poppet 30 is opened again, the first compression coil spring 40a having a low spring constant may not have a sufficient elastic restoring force, so that it may delay the return of the poppet 30 to the open state.

Since the injection process is performed repeatedly and continuously, if only the first compression coil spring 40a is used, the fatigue is accumulated and the durability is rapidly reduced, so that a normal elastic force cannot be exerted. Therefore, problems caused by the replacement of components may occur additionally.

In the present invention, the second compression coil spring 50a is additionally used to provide the gas exhausting device that is improved in durability by dispersing the fatigue caused by the repeated work and has reliability to continuously ensure the opening and closing of the poppet 30.

Next, when the injection-molded article molded in the cavity is withdrawn as the injection process is completed, the pressure applied to the head 32 of the poppet 30 is released, so that the head 32 of the poppet 30 moves as the compressed first compression coil spring 40a extends, thereby opening the first gas introduction path 11 again. At this time, the second compression coil spring 50a returns while being compressed again.

Importantly, the vacuum pressure applied to suck the gas is removed at the end of the injection, so that the head of the poppet can be restored very rapidly.

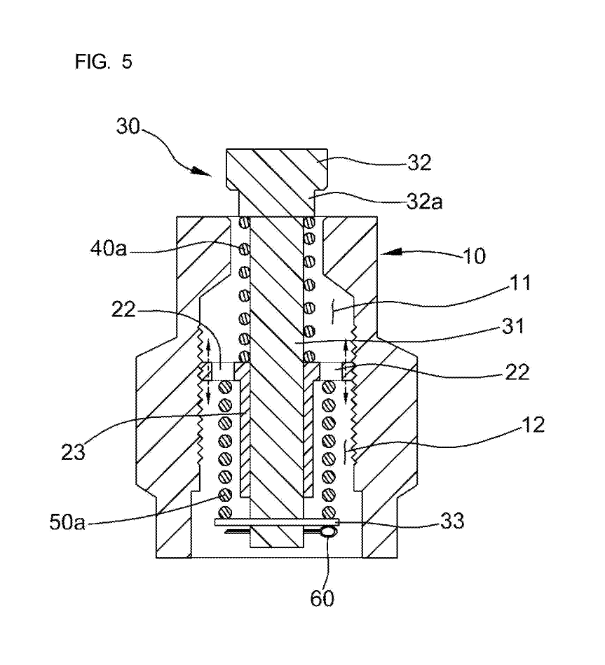

FIG. 5 is a view showing another embodiment of the present invention.

As shown in the drawings, the introduction holder 20 is screw-coupled with the inner peripheral surface of the introduction socket 10, such that the introduction holder 20 is movable along the inner circumferential surface of the introduction socket 10.

In other words, a female screw thread is provided on the inner peripheral surface of the introduction socket 10, and a male screw thread is provided on the outer peripheral surface of the introduction holder 20, so that the introduction holder 20 may rotate to vertically move along an inner periphery of the introduction socket 10.

Therefore, compression levels of the first compression coil spring 40a and the second compression coil spring 50a can be adjusted by moving the introduction holder 20. In other words, the elastic force of the first compression coil spring 40a and the second compression coil spring 50a may be adjusted simultaneously.

For example, when the introduction holder 20 moves toward the first compression coil spring 40a, the elastic force of the first compression coil spring 40a is increased while the elastic force of the second compression coil spring 50a is decreased, and when the introduction holder 20 moves toward the second compression coil spring 50a, the elastic force of the second compression coil spring 50a is increased while the elastic force of the first compression coil spring 40a is decreased.

Accordingly, the gas exhausting device for the injection mold according to the present invention may easily adjust the distance between the head 32 of the poppet 30 and the first gas introduction path 11 by easily adjusting the elastic force of the first compression coil spring 40a and the second compression coil spring 50a through the introduction holder 20.

### Embodiment

In the present invention, if the spring constant of the first compression coil spring 40a is 100, the spring constant of the second compression coil spring 50a may be 50 or more and 70 or less.

When the first compression coil spring 40a and the second compression coil spring 50a are mounted in a compressed state, if the compressed length of the first compression coil spring 40a is 1, the compressed length of the second compression coil spring 50a may be relatively 3 to 4.

In addition, when the poppet 30 is completely closed, the compressed length of the first compression coil spring 40a may be approximately 2 to 3. If the compressed length of the first compression coil spring 40a is 2, the compressed length of the second compression coil spring 50a may be relatively 2 to 3.

In addition, assuming the compressive force acting on the head 32 is 100 in the case where only the first compression coil spring 40a is mounted and the poppet 30 is completely closed, the compressive force acting on the head 32 is approximately 80 to 90 in the case where both the first compression coil spring 40a and the second compression coil spring 50a are mounted and the poppet 30 is completely closed as in the present invention. In other words, when the second compression coil spring 50a is mounted, the poppet 30 may be closed even at a reduced compressive force, which is approximately 80% to 90% compared to the related art.

Therefore, even if the spring constant of the first compression coil spring 40a is increased to smoothly open the poppet 30 after the injection process is completed, there is an effect of reducing the spring constant of the first compression coil spring 40a due to the second compression coil spring 50a during the injection process, so that the poppet 30 may be easily closed. In addition, since two compression coil springs are used, the fatigue caused by repeated loads is dispersed, so that the durability is remarkably improved.

Note that the values of the above embodiments are design values obtained from a shoe mold and calculated through numerous tests with trial and error. In other words, if it is beyond the range of the respective numerical values, the gas may not be discharged because the poppet may be closed in advance, or the molten resin may flow out because the poppet does may not be closed even by the injection pressure.

While the representative embodiments of the present invention have been described above with reference to the drawings, various applications and modifications can be made by those skilled in the art without departing from the spirit and scope of the invention based on the above description. Thus, the scope of the present invention should not be limited by the above-described embodiments, but should be defined according to the following claims and their equivalents.

What is claimed is:

1. A gas exhausting device for an injection mold, the gas exhausting device comprising:
an introduction socket having a tubular shape, provided in a discharge path which is formed through an inner surface of the injection mold, and allowing a cavity to communicate with an outside to introduce and discharge a gas remaining in the cavity;
an introduction holder provided at an inner portion of the introduction socket in a transverse direction to divide the inner portion of the introduction socket into a first gas introduction path and a second gas introduction path, formed at a center thereof with a central hole through which a poppet penetrates, and having a plurality of gas communication paths formed around an outer side of the central hole;
a poppet including a body penetrating through the central hole, a head formed at one end of the body to open and close the first gas introduction path by reciprocating movement, and a support ring provided at an opposite end of the body;
a first elastic member interposed between the head of the poppet and the introduction holder to elastically support one end of the poppet; and
a second elastic member interposed between the support ring of the poppet and the introduction holder to elastically support an opposite end of the poppet,
wherein the first elastic member includes a first compression coil spring installed in a compressed state,
the second elastic member includes a second compression coil spring installed in a compressed state, and
a spring constant of the first compression coil spring is larger than a spring constant of the second compression coil spring.

2. The gas exhausting device for the injection mold of claim 1, wherein a diameter of the second compression coil spring is larger than a diameter of the first compression coil spring.

3. The gas exhausting device for the injection mold of claim 1, wherein when the head of the poppet blocks the first gas introduction path, the first compression coil spring is further compressed, and the second compression coil spring extends by a compressed length of the first compression coil spring while maintaining a compressed state without being completely released.

4. The gas exhausting device for the injection mold of claim 1, wherein a linear guide having a tubular shape is installed in the central hole of the introduction holder to guide the body of the poppet.

5. The gas exhausting device for the injection mold of claim 1, wherein the support ring includes a washer that is able to be fitted to the body of the poppet,
a pin hole is formed at an end portion of the body, and
a support pin is inserted into the pin hole to prevent the washer from being separated.

6. The gas exhausting device for the injection mold of claim 1, wherein the introduction socket is provided on an outer peripheral surface thereof with a male screw thread to allow the introduction socket to be screw-coupled to the mold.

7. The gas exhausting device for the injection mold of claim 1, wherein the introduction holder is screw-coupled with an inner peripheral surface of the introduction socket, such that the introduction holder is vertically movable.
